(19) United States
(12) Patent Application Publication
(10) Pub. No.: US 2007/0171062 A1
(43) Pub. Date: Jul. 26, 2007

(54) Tree stand locating system

(76) Inventor: James Michael Powell, Davie, FL (US)

Correspondence Address: David O. Simmons;Galasso & Associates LP, P.O. Box 26503, Austin, TX, 78755-0503, US

(21) Appl. No.: 11/337,009

(22) Filed: Jan. 20, 2006

(51) Int. Cl. G08B 13/14; G08B 23/00

(52) U.S. Cl. 340/568.4; 340/573.1

(57) ABSTRACT

A tree stand locating system comprises a remote control unit, a base unit and a lanyard. The remote control unit includes a lanyard interconnect. The base unit includes an audible output device and a lanyard interconnect. The lanyard includes an end portion configured for being detachably attached to one of the lanyard interconnect of the base unit and the lanyard interconnect of the remote control unit. The base unit is configured for emitting an audible alert signal from the audible output device when the lanyard is detached from said one of the lanyard interconnect of the base unit and the lanyard interconnect of the remote control unit.

### FIELD OF THE DISCLOSURE

The disclosures made herein relate generally to tree stands for hunters and, more particularly, to devices configured for locating a tree stand and/or providing for safety in the event of a hunter falling from the tree stand.

### BACKGROUND

In hunting or observing wildlife in their natural habitat, it is a well-known practice for sportsmen or naturalists to utilize a support platform attached to a tree or the like. Such a support platform is commonly referred to as a “tree stand”. The sportsman or naturalist perched on the tree stand is positioned at an elevation where he or she can readily observe wildlife while remaining substantially unobserved. In part, the ability to remain unobserved by wildlife (e.g., animals) is due to the fact that the scent of the person perched on the elevated platform is above the level of the wildlife foraging on the ground. For the purposes of hunting, the elevated vantage point from the tree stand also aids in line of sight to a desired target.

A tree stand is generally mounted on a tree in dense woodlands or forest at a remote relatively location, which may be totally or partially unfamiliar to the person who installs and/or will be using the tree stand. Due to these situations, it is not uncommon for a person to have difficulty in finding the tree stand, even though they might have been the person who installed it. Therefore, various types of known tree stand locating devices are available for aiding a person in finding an installed tree stand during daylight and nighttime conditions.

The mounted height of a tree stand has a significant impact on identifying, observing, targeting and/or firing upon a particular animal. To this end, tree stands are regularly mounted at a height where severe injury and/or death can occur if the person using the tree stand falls from it. A tree stand is a relatively small structure, which increases the potential for a fall. Because of the remote location where a tree stand is typically located, a person who has fallen and requires medical assistance may lay injured and/or unconscious for a lengthy period of time before another person happens to find them.

Therefore, a tree stand locating system that is configured for providing tree stand locating functionality and/or emergency alert functionality in the event of a person falling from the tree stand fulfils one or more needs unmet by conventional tree stand locating devices and is, thus, useful and advantageous.

### SUMMARY OF THE DISCLOSURE

Embodiments of the present invention relate to a tree stand tree stand locating system that is configured for locating a tree stand and providing for emergency alert functionality in the event of a person falling from the tree stand. More specifically, embodiments of the present invention use visual alert indicators for identifying a location of a tree stand and use visual and/or audible alert indicators for identifying the location of a person who has fallen from a tree stand position. In doing so, embodiments of the present invention advantageously fulfill one or more needs unmet by conventional tree stand locating devices.

In one embodiment of the present invention, a tree stand locating system comprises a remote control unit, a base unit and a lanyard. The remote control unit includes a lanyard interconnect. The base unit includes an audible output device and a lanyard interconnect. The lanyard includes an end portion configured for being detachably attached to one of the lanyard interconnect of the base unit and the lanyard interconnect of the remote control unit. The base unit is configured for emitting an audible alert signal from the audible output device when the lanyard is detached from the lanyard interconnect of the base unit and/or the lanyard interconnect of the remote control unit.

In another embodiment of the present invention, a tree stand locating system comprises a remote control unit, a base unit and a lanyard. The remote control unit includes an audible output device, a locator activation selector, a locator de-activation selector, logic circuitry, a control signal transmitter and a lanyard interconnect. The base unit includes an audible output device, a visual output device, logic circuitry, a control signal receiver and a lanyard interconnect. The lanyard includes a first end portion configured for being detachably attached to the lanyard interconnect of the base unit and a second end portion configured for being detachably attached to the lanyard interconnect of the remote control unit. The control signal transmitter and the logic circuitry of the remote control unit are jointly configured for emitting a locator activation signal when the locator activation selector is selected and for emitting a locator de-activation signal when the locator de-activation selector is selected. The control signal receiver and the logic circuitry of the base unit are jointly configured for receiving the locator activation signal emitted by the remote control unit and for receiving the locator de-activation signal emitted by the remote control unit. The logic circuitry of the base unit is configured for activating the visual output device in response to receiving the locator activation signal emitted by the remote control unit and for deactivating the visual output device in response to receiving the locator de-activation signal emitted by the remote control unit. The logic circuitry of the remote control unit is configured for causing an audible alert signal to be emitted from the audible output device of the remote control unit when the lanyard is detached from the lanyard interconnect of the base unit and/or the lanyard interconnect of the remote control unit. The logic circuitry of the base unit is configured for causing an audible alert signal and a visual alert signal to be emitted from the audible output device and the visual output device, respectively, of the base unit when the lanyard is detached from the lanyard interconnect of the base unit and/or the lanyard interconnect of the remote control unit.

In another embodiment of the present invention, a method for providing tree stand locating functionality and emergency alert functionality for a person using the tree stand begins with an operation for selectively controlling activation and deactivation of a visual output device of a base unit in response to receiving a locator activation signal emitted by a remote control unit and receiving a locator de-activation signal emitted by the remote control unit, respectively. An operation for arming emergency alert functionality is performed in response to providing electrical power to emergency alert circuitry after connecting a lanyard between a lanyard interconnect of the base unit and a lanyard interconnect of the remote control unit. The emergency alert functionality is performed after arming the emergency alert functionality circuit is performed and in response to the lanyard being detached from the lanyard interconnect of the base unit and/or the lanyard interconnect of the remote control unit.

Turning now to specific aspects of the present invention, in at least one embodiment, the lanyard includes a wire electrically connected between a first electrical connector and a second electrical connector thereby enabling electrical connection of the base unit with the remote control unit through the lanyard, the first electrical connector and the lanyard interconnect of the remote control unit are jointly configured for enabling electrical interconnection therebetween, and the second electrical connector and the lanyard interconnect of the base unit are jointly configured for enabling electrical interconnection therebetween.

In at least one embodiment of the present invention, the base unit includes two visual output devices mounted within a housing, a first one of the visual output devices extends through a first face of the housing, a second one of the visual output devices extends through a second face of the housing and at least one of the visual output devices emits a visual alert signal while the audible alert signal is being emitted.

In at least one embodiment of the present invention, the locator activation selector includes a first depressible button coupled to the logic circuitry of the remote control unit and the locator de-activation selector includes a second depressible button coupled to the logic circuitry of the remote control unit.

In at least one embodiment of the present invention, the base unit includes a emergency alert functionality arming switch, the emergency alert functionality is armed when the emergency alert functionality arming switch is in a first position and is disarmed when the emergency alert functionality arming switch is in a second position, and the emergency alert functionality includes emitting an audible alert signal from the audible output device of the base unit and/or the audible output device of the remote control unit when the lanyard is detached from the lanyard interconnect of the base unit and/or the lanyard interconnect of the remote control unit.

In at least one embodiment of the present invention, selectively controlling activation and deactivation includes causing the visual output device of the base unit to emit a visual alert signal when activated and causing the visual output device of the base unit to cease emitting the visual alert signal when deactivated.

In at least one embodiment of the present invention, providing electrical power to the emergency alert functionality circuitry includes causing electrical current to flow through the emergency alert functionality circuitry.

In at least one embodiment of the present invention, the emergency alert functionality includes causing an audible alert signal to be emitted from an audible output device of the base unit and/or an audible output device of the remote control unit and/or causing a visual alert signal to be emitted from the visual output device of the base unit.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts an embodiment of a tree stand locator system in accordance with the present invention.

FIG. 2 is a high-level block diagram representing functional components of the tree stand locator system depicted in FIG. 1.

FIG. 3 is an illustrative view depicting a use configuration of the tree stand locator system depicted in FIG. 1.

### DETAILED DESCRIPTION OF THE DRAWING FIGURES

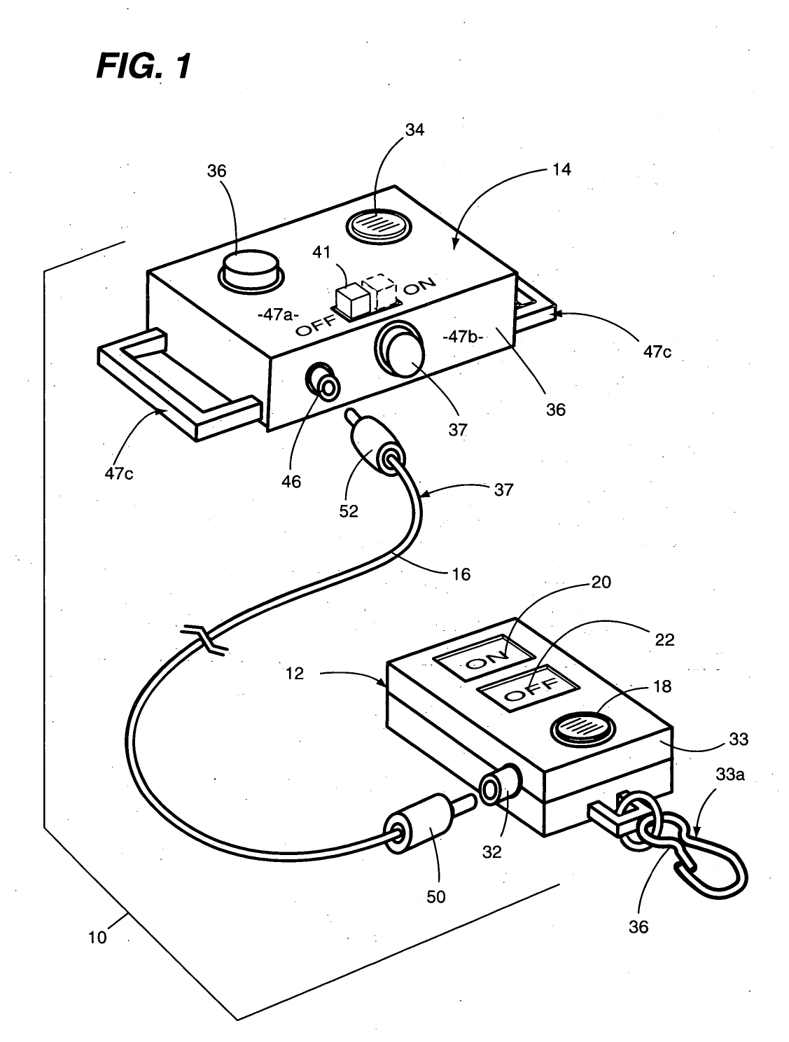

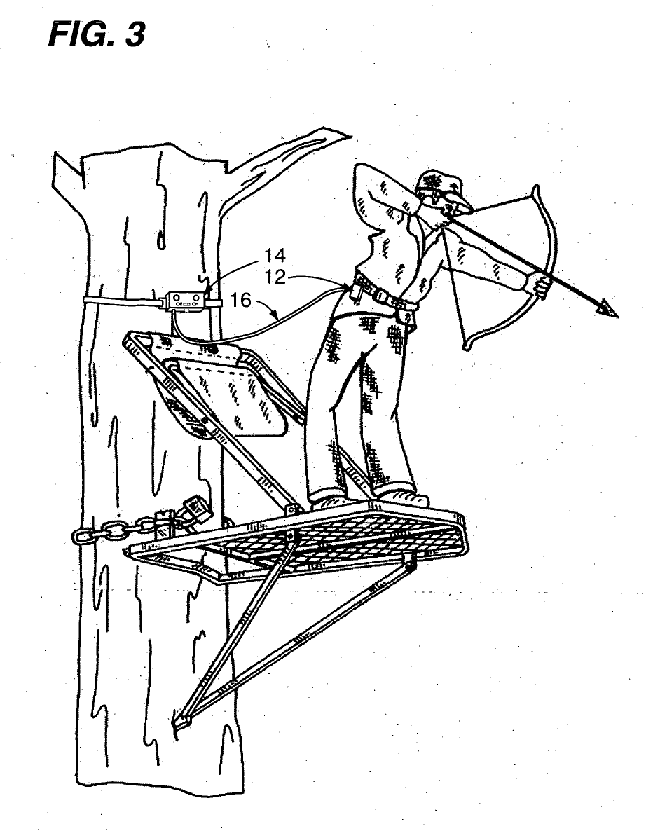

FIGS. 1-3 depicts an embodiment of a tree stand locating system in accordance with the present invention. The depicted tree stand locating system is referred to herein as the tree stand locating system 10. The tree stand locating system 10 is advantageously configured for assisting in locating of an installed tree stand and for providing visual and/or audible alert signals in the case that a person using an installed tree stand has fallen from the installed tree stand position (i.e., fallen off the installed tree stand or fallen as a result of the tree stand falling from the installed position). In this manner, the tree stand locating system 10 advantageously fulfills one or more needs unmet by conventional tree stand locating devices.

The tree stand locating system 10 includes a remote control unit 12, a base unit 14 and a lanyard 16. As will be disclosed below in greater detail, the remote control unit 12, the base unit 14 and the lanyard 16 are inter-connectable and interoperable for advantageously providing locator functionality and emergency alert functionality. The locator functionality includes the remote control unit 12 being used for causing the base unit 14 to emit a visual alert signal (e.g., a flashing light) for assisting a person to locate the base unit 14. By mounting the base unit 14 on or on a tree near a tree stand, such visual alert signal indicates a location of the tree stand. The emergency alert functionality includes the remote control unit 12 and/or the base unit 14 the base unit 14 being maintained in an armed condition while the lanyard is connected between the remote control unit 12 and the base unit 14. The remote control unit 12 is attached to the person on the tree stand and/or to the tree stand. Thus, in the case of the tree stand and/or the person falling from the installed position of the tree stand, detachment of the lanyard 16 from either the remote control unit 12 or the base unit 14 causing the remote control unit 12 to emit a visual alert signal and the base unit 14 to emit a visual alert signal and/or an audible alert signal (e.g., a loud noise). The visual and/or audible alert signals advantageously serve to draw attention to the fallen person, who may be injured.

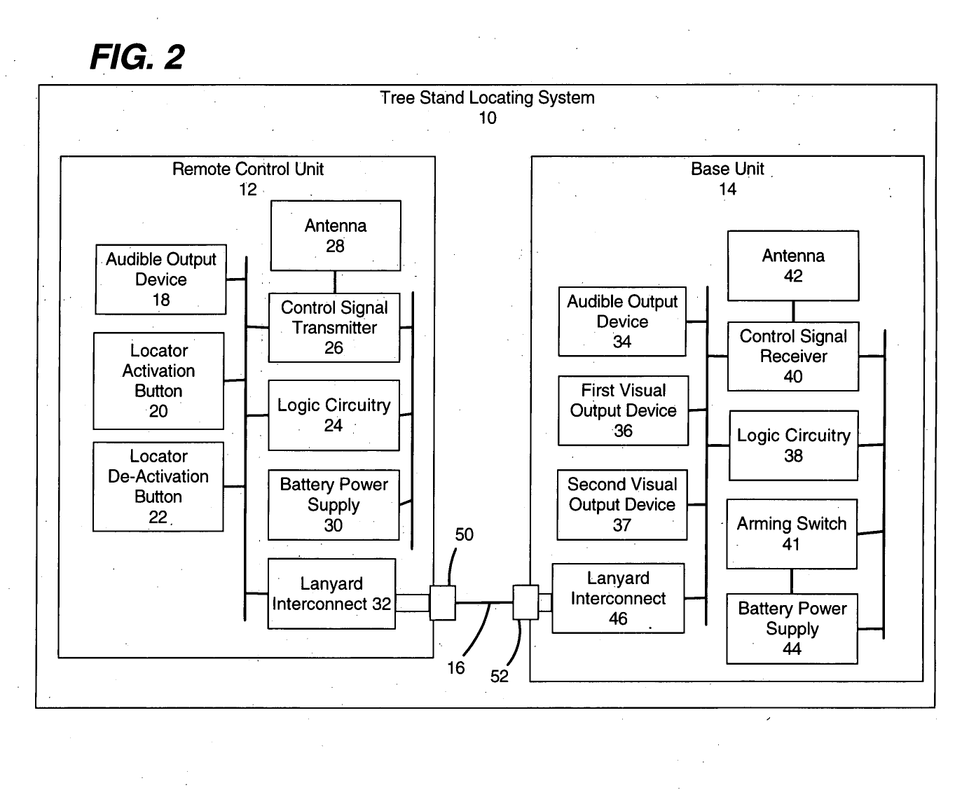

Referring now to FIGS. 1 and 2, the remote control unit 12 includes an audible output device 18, a locator activation button 20, a locator de-activation button 22, logic circuitry 24 (FIG. 2), a control signal transmitter 26 (FIG. 2), an antenna 28, a battery power supply 30 and a lanyard interconnect 32. The audible output device 18 (e.g., a buzzer, a speaker, etc.), the locator activation button 20, the locator de-activation button 22, the logic circuitry 24 (FIG. 2), the control signal transmitter 26 (FIG. 2) and the lanyard interconnect 32 are interconnected for enabling interaction therebetween. The antenna 28 is connected to the control signal transmitter 26 for enabling signals 28 to be broadcast (i.e., emitted) from the remote control unit 12. The battery power supply 30 is connected to the logic circuitry 24 and to the control signal transmitter 26 for supplying electrical power to the logic circuitry 24 and the control signal transmitter 26.

The audible output device 18, the locator activation button 20, the locator de-activation button 22, the logic circuitry 24, the control signal transmitter 26, the antenna 28, the battery power supply 30 and the lanyard interconnect 32 are contained in a remote control unit housing 33 (FIG. 1). The remote control unit housing 33 includes an attachment structure 33a. The attachment structure 33a is configured for enabling the remote control unit 12 to be attached to a person (e.g., to their clothing, their clothing accessories, etc.). The present invention is not limited by a particular configuration of means for enabling the remote control unit to be attached to a person's clothing or clothing accessories.

The base unit 14 including an audible output device 34 (e.g., a buzzer, a speaker, etc.), a first visual output device 36 (e.g., an LED), a second visual output device 37, logic circuitry 38, a control signal receiver 40, a emergency alert functionality arming switch 41, an antenna 42, a battery power supply 44 and a lanyard interconnect 46. The audible output device 34, the first visual output device 36, the second visual output device 37, the logic circuitry 38, the control signal receiver 40 and the emergency alert functionality arming switch 41 are interconnected for enabling interaction therebetween. The battery power supply 44 is connected to the logic circuitry 38 and to the control signal receiver 40 for supplying electrical power to the logic circuitry 38 and the control signal receiver 40.

The first visual output device 36, the second visual output device 37, the logic circuitry 38, the control signal receiver 40, the emergency alert functionality arming switch 41, the antenna 42, the battery power supply 44 and the lanyard interconnect 46 are contained in a base unit housing 47 (FIG. 1). The first visual output device 36 of the base unit 14 extends through a first face 47a of the base unit housing 47 and the second visual output device 37 extends through a second face 47b of the housing 47. In this manner, the probability of at least one of the visual output devices (36, 37) being visible is enhanced. The base unit housing 47 includes attachment structures 47c extending from opposing side faces. The attachment structure 47c is configured for enabling a retaining member such as a strap or chain to be used for securing the base unit 14 to a tree stand, a person using the tree stand or an article supported by the tree stand. The present invention is not limited by a particular configuration of means for enabling the base unit 14 to be attached to an object.

The lanyard 16 includes a wire 48 electrically connected between a first electrical connector 50 (i.e., a first end portion) and a second electrical connector 52 (i.e., a second end portion). The first electrical connector 50 and the lanyard interconnect 32 of the remote control unit 12 are jointly configured for enabling electrical interconnection therebetween and for being detachably attached to each other. The second electrical connector 52 and the lanyard interconnect 46 of the base unit are jointly configured for enabling electrical interconnection therebetween and for being, detachably attached to each other. Accordingly, the lanyard 16 provides for electrical connection of the base unit with the remote control unit in a detachable manner. The level of force required to detach the first electrical connector 50 from the lanyard interconnect 32 of the remote control unit 12 and the level of force required to detach the second electrical connector 52 from the lanyard interconnect 46 of the base unit 14 is sufficient to maintain contact with normal movement of the lanyard 16, but allowing for ready detachment in the case of an average size person's full weight exerted on the lanyard 16.

The control signal transmitter 26 and the logic circuitry 24 of the remote control unit 12 are jointly configured for emitting a locator activation signal when the locator activation button 20 is depressed and for emitting a locator de-activation signal when the locator de-activation button 22 is depressed. The present invention is not limited by a particular configuration (e.g., wavelength) signal transmission. The locator activation button 20 is an example of a locator activation selector in accordance with the present invention and the locator de-activation button 22 is an example of a locator de-activation selector in accordance with the present invention. It is disclosed herein that the locator activation button 20 and the locator de-activation button 22 may be implemented as a single button whereby the logic circuitry 24 of the remote control unit 12 sends the locator activation signal and the locator de-activation signal in an alternating sequence with each successive depression of the single button.

With respect to locator functionality, the control signal receiver 40 and the logic circuitry 38 of the base unit 14 are jointly configured for receiving the locator activation signal emitted by the remote control unit 12 and for receiving the locator de-activation signal emitted by the remote control unit 12. The logic circuitry 38 of the base unit 14 is further configured for activating the visual output device 36 in response to receiving the locator activation signal emitted by the remote control unit 12 and for deactivating the visual output device 36 in response to receiving the locator de-activation signal emitted by the remote control unit 12.

With respect to emergency alert functionality, the logic circuitry 24 of the remote control unit 12 is configured for causing an audible alert signal to be emitted from the audible output device 18 of the remote control unit 12 when the lanyard 16 is detached from the lanyard interconnect 46 of the base unit 14 or the lanyard interconnect 32 of the remote control unit 12. The logic circuitry 38 of the base unit 14 is configured for causing an audible alert signal and a visual alert signal to be emitted from the audible output device 34 and the visual output device 36, respectively, of the base unit 14 when the lanyard 16 is detached from the lanyard interconnect 46 of the base unit 14 or the lanyard interconnect 32 of the remote control unit 12. The emergency alert functionality is armed when the emergency alert functionality arming switch 41 is in an ‘ON’ position and is disarmed when the emergency alert functionality arming switch is in an ‘OFF’ position.

In use, the lanyard 16 is connected to the lanyard interconnect 46 of the base unit 14 and the lanyard interconnect 32 of the remote control unit 12 while the emergency alert functionality arming switch 41 is in the ‘OFF’ position. With the emergency alert functionality arming switch 41 in the ‘OFF’ position, the emergency alert signal is not emitted from the base unit 14 or remote control unit 12 even though the lanyard 16 is not connected to the both the lanyard interconnect 46 of the base unit 14 or the lanyard interconnect 32 of the remote control unit 12. After the lanyard 16 is connected to the lanyard interconnect 46 of the base unit 14 and to the lanyard interconnect 32 of the remote control unit 12, the emergency alert functionality arming switch 41 is moved to the ‘ON’ position, thereby activating emergency alert functionality.

It is disclosed herein that the base unit 14 may includes a plurality of lanyard interconnects. At least two of the lanyard interconnects of the base unit 14 provide electrical interconnect functionality as described above. In such an embodiment, additional remote control units and lanyards as disclosed above are used to facilitate emergency alert functionality that is triggered via different objects. For example, a first remote control unit (i.e., the remote control unit 12) is attached to a person on a tree stand and a second remote control unit is attached to the tree stand. By connecting lanyards between the base unit 14 and each of the remote control units, emergency alert functionality is triggered by any one of the lanyards becoming disconnected from the base unit 14 or one of the remote control units.

It is disclosed herein that, in one embodiment of the present invention, a lanyard in accordance with the present invention does not provide for electrical continuity between the first electrical connector 50 and the second electrical connectors 52. In such an embodiment, the remote control unit 12 and the base unit 14 are configured to recognize the presence of the lanyard 16 being engaged therewith and being detached therefrom. For example, the connectors (50, 52) are mechanical keys that are engagable with the remote control unit 12 and the base unit 14 for enable arming and triggering. Wireless communication is used for facilitating communication between the remote control unit 12 and the base unit 14.

It is disclosed herein that, in one embodiment of the present invention, the base unit 14 may include one or more lanyard interconnects that are configured such that a lanyard by itself may be used to facilitate emergency alert functionality. In such an embodiment, the lanyard has a single connector at a first end portion thereof that is engaged with a mating lanyard interconnect of the base unit 14. Once the single connector is engaged with the lanyard interconnect of base unit 14, emergency alert functionality in accordance with the present invention is armed. A second end portion of the lanyard is mechanically attached to a desired object (e.g., the tree stand, a person, etc). In this manner, emergency alert functionality is triggered when sufficient force is exerted on the lanyard to detach the single connector of the lanyard from the lanyard interconnect of the base unit 14 (e.g., the desired object falling from the installed location of the tree stand). Such an embodiment advantageously eliminates cost and complexity of configuring a remote control unit to provide for emergency alert functionality. Such a remote control unit supports only tree stand locating functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A tree stand locating system, comprising:
a remote control unit including a lanyard interconnect;
a base unit including an audible output device and a lanyard interconnect; and
a lanyard including an end portion configured for being detachably attached to one of the lanyard interconnect of the base unit and the lanyard interconnect of the remote control unit;
wherein the base unit is configured for emitting an audible alert signal from the audible output device when the lanyard is detached from said one of the lanyard interconnect of the base unit and the lanyard interconnect of the remote control unit.

2. The tree stand locating system of claim 1 wherein:
the lanyard includes a wire electrically connected between a first electrical connector and a second electrical connector thereby enabling electrical connection of the base unit with the remote control unit through the lanyard;
the first electrical connector and the lanyard interconnect of the remote control unit are jointly configured for enabling electrical interconnection therebetween; and
the second electrical connector and the lanyard interconnect of the base unit are jointly configured for enabling electrical interconnection therebetween.

3. The tree stand locating system of claim 1 wherein:
the base unit includes two visual output devices mounted within a housing;
a first one of said visual output devices extends through a first face of the housing;
a second one of said visual output devices extends through a second face of the housing; and
at least one of said visual output devices illuminates while the audible alert signal is being emitted.

4. The tree stand locating system of claim 1 wherein:
the base unit includes an emergency alert functionality arming switch;
said emergency alert functionality is armed when the emergency alert functionality arming switch is in a first position and is disarmed when the emergency alert functionality arming switch is in a second position; and
said emergency alert functionality includes emitting an audible alert signal from the audible output device when the lanyard is detached from said one of the lanyard interconnect of the base unit and the lanyard interconnect of the remote control unit while said emergency alert functionality is armed.

5. The tree stand locating system of claim 4 wherein:
the lanyard includes a wire electrically connected between a first electrical connector and a second electrical connector thereby enabling electrical connection of the base unit with the remote control unit through the lanyard;
the first electrical connector and the lanyard interconnect of the remote control unit are jointly configured for enabling electrical interconnection therebetween;
the second electrical connector and the lanyard interconnect of the base unit are jointly configured for enabling electrical interconnection therebetween;
the base unit includes two visual output devices mounted within a housing;
a first one of said visual output devices extends through a first face of the housing;
a second one of said visual output devices extends through a second face of the housing; and
at least one of said visual output devices illuminates while the audible alert signal is being emitted.

6. A tree stand locating system, comprising:
a remote control unit including an audible output device, a locator activation selector, a locator de-activation selector, logic circuitry, a control signal transmitter and a lanyard interconnect;
a base unit including an audible output device, a visual output device, logic circuitry, a control signal receiver and a lanyard interconnect; and
a lanyard including a first end portion configured for being detachably attached to the lanyard interconnect of the base unit and a second end portion configured for being detachably attached to the lanyard interconnect of the remote control unit;
wherein the control signal transmitter and said logic circuitry of the remote control unit are jointly configured for emitting a locator activation signal when the locator activation selector is selected and for emitting a locator de-activation signal when the locator de-activation selector is selected;
wherein the control signal receiver and said logic circuitry of the base unit are jointly configured for receiving the locator activation signal emitted by the remote control unit and for receiving the locator de-activation signal emitted by the remote control unit;
wherein said logic circuitry of the base unit is configured for activating the visual output device in response to receiving the locator activation signal emitted by the remote control unit and for deactivating the visual output device in response to receiving the locator de-activation signal emitted by the remote control unit;
wherein said logic circuitry of the remote control unit is configured for causing an audible alert signal to be emitted from the audible output device of the remote control unit when the lanyard is detached from at least one of the lanyard interconnect of the base unit and the lanyard interconnect of the remote control unit; and
wherein said logic circuitry of the base unit is configured for causing an audible alert signal and a visual alert signal to be emitted from the audible output device and the visual output device, respectively, of the base unit when the lanyard is detached from at least one of the lanyard interconnect of the base unit and the lanyard interconnect of the remote control unit.

7. The tree stand locating system of claim 6 wherein:
the lanyard includes a wire electrically connected between a first electrical connector and a second electrical connector thereby enabling electrical connection of the base unit with the remote control unit through the lanyard;
the first electrical connector and the lanyard interconnect of the remote control unit are jointly configured for enabling electrical interconnection therebetween; and
the second electrical connector and the lanyard interconnect of the base unit are jointly configured for enabling electrical interconnection therebetween.

8. The tree stand locating system of claim 6 wherein:
the base unit includes two visual output devices mounted within a housing;
a first one of said visual output devices extends through a first face of the housing;
a second one of said visual output devices extends through a second face of the housing; and
at least one of said visual output devices emits a visual alert signal while the audible alert signal is being emitted.

9. The tree stand locating system of claim 6 wherein:
the locator activation selector includes a first depressible button coupled to said logic circuitry of the remote control unit; and
the locator de-activation selector includes a second depressible button coupled to said logic circuitry of the remote control unit.

10. The tree stand locating system of claim 6 wherein:
the base unit includes a emergency alert functionality arming switch;
said emergency alert functionality is armed when the emergency alert functionality arming switch is in a first position and is disarmed when the emergency alert functionality arming switch is in a second position; and
said emergency alert functionality includes emitting an audible alert signal from at least one of the audible output device of the base unit and the audible output device of the remote control unit when the lanyard is detached from said at least one of the lanyard interconnect of the base unit and the lanyard interconnect of the remote control unit.

11. The tree stand locating system of claim 10 wherein:
the lanyard includes a wire electrically connected between a first electrical connector and a second electrical connector thereby enabling electrical connection of the base unit with the remote control unit through the lanyard;
the first electrical connector and the lanyard interconnect of the remote control unit are jointly configured for enabling electrical interconnection therebetween;
the second electrical connector and the lanyard interconnect of the base unit are jointly configured for enabling electrical interconnection therebetween;
the base unit includes two visual output devices mounted within a housing;
a first one of said visual output devices extends through a first face of the housing;
a second one of said visual output devices extends through a second face of the housing;
at least one of said visual output devices emits a visual alert signal while the audible alert signal is being emitted;
the locator activation selector includes a first depressible button coupled to said logic circuitry of the remote control unit; and
the locator de-activation selector includes a second depressible button coupled to said logic circuitry of the remote control unit.

12. A method for locating a tree stand and providing emergency alert functionality for a person using the tree stand, comprising:
selectively controlling activation and deactivation of a visual output device of a base unit in response to receiving a locator activation signal emitted by a remote control unit and receiving a locator de-activation signal emitted by the remote control unit, respectively;
arming emergency alert functionality in response to providing electrical power to emergency alert circuitry after connecting a lanyard between a lanyard interconnect of the base unit and a lanyard interconnect of the remote control unit; and
performing said emergency alert functionality after said arming emergency alert functionality circuit is performed and in response to the lanyard being detached from at least said one of the lanyard interconnect of the base unit and the lanyard interconnect of the remote control unit.

13. The method of claim 12 wherein said selectively controlling activation and deactivation includes causing the visual output device of the base unit to emit a visual alert signal when activated and causing the visual output device of the base unit to cease emitting the visual alert signal when deactivated.

14. The method of claim 12 wherein providing electrical power to said emergency alert functionality circuitry includes causing electrical current to flow through said emergency alert functionality circuitry.

15. The method of claim 12 wherein said emergency alert functionality includes at least one of:
causing an audible alert signal to be emitted from at least one of an audible output device of the base unit and an audible output device of the remote control unit; and
causing a visual alert signal to be emitted from the visual output device of the base unit.

16. The method of claim 15 wherein:
said selectively controlling activation and deactivation includes causing the visual output device of the base unit to emit a visual alert signal when activated and causing the visual output device of the base unit to cease emitting the visual alert signal when deactivated; and
providing electrical power to said emergency alert functionality circuitry includes causing electrical current to flow through said emergency alert functionality circuitry.
